(19) United States
(12) Patent Application Publication
(10) Pub. No.: US 2007/0162713 A1
(43) Pub. Date: Jul. 12, 2007

(54) Memory having status register read function

(76) Inventors: Josef Schnell, Charlotte, VT (US); Margaret Clark Freebern, Richmond, VT (US); Alan Deng, Morrisville, NC (US); Bhaskar Shrestha, Winooski, VT (US)

Correspondence Address: DICKE, BILLIG & CZAJA, FIFTH STREET TOWERS, 100 SOUTH FIFTH STREET, SUITE 2200, MINNEAPOLIS, MN, 55402, US

(21) Appl. No.: 11/328,037

(22) Filed: Jan. 9, 2006

(51) Int. Cl. G06F 13/00

(52) U.S. Cl. 711/156

(57) ABSTRACT

A memory includes a status register and a read/write data bus. The status register is configured to pass status register values to the read/write data bus in response to a status register read command.

### BACKGROUND

Some Random Access Memories (RAMs), such as a Dynamic Random Access Memories (DRAMs), Synchronous Dynamic Random Access Memories (SDRAMs), Double Data Rate Synchronous Dynamic Random Access Memories (DDR-SDRAMs), or low power SDRAMs, include one or more status registers for storing the states of internal signals or other data within a memory chip.

Typically, status information stored in the one or more status registers is not readable by the host after the memory chip is packaged and incorporated into a product. During manufacturing and testing of the memory chip, systems may access the one or more status registers to read information, such as internal operating signal values and status information. The status information may include information such as operating temperature, serial number, etc. Once the memory chip is packaged and incorporated into a product, however, the user of the product typically cannot access any of the internal operating signal values and status information that was available during the manufacturing and testing of the memory chip.

The status data, if available after memory chip packaging and incorporation into a product, could be used for optimizing the operation of the memory chip within the product, for monitoring the memory chip for errors, or for other suitable purposes that would be of value to the product manufacturer or end user.

### SUMMARY

One embodiment of the present invention provides a memory. The memory includes a status register and a read/write data bus. The status register is configured to pass status register values to the read/write data bus in response to a status register read command.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a block diagram illustrating one embodiment of a memory system.

FIG. 2 is a block diagram illustrating one embodiment of a memory.

FIG. 3 is a timing diagram illustrating one embodiment of the timing of signals for the memory.

### DETAILED DESCRIPTION

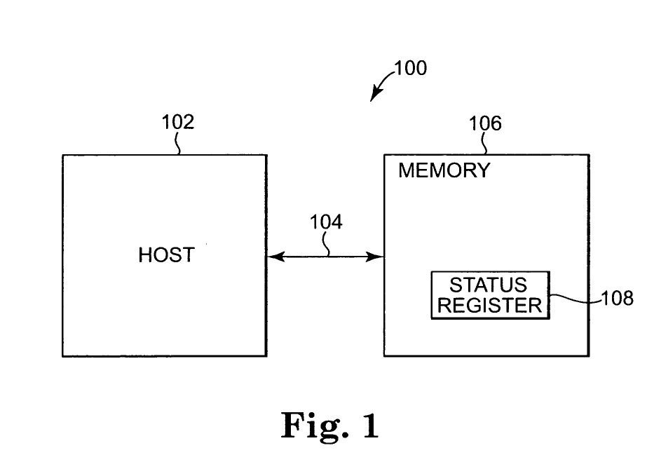

FIG. 1 is a block diagram illustrating one embodiment of a memory system 100. Memory system 100 includes host 102 and memory 106. Host 102 is electrically coupled to memory 106 through memory communication path 104. Memory 106 includes a status register 108. Host 102 reads data from memory 106 and writes data to memory 106 through memory communication path 104. Host 102 also reads status information from status register 108 through memory communication path 104.

Data stored in memory 106 and status information stored in status register 108 are both passed to host 102 through data pads or pins (DQs) of memory 106. In response to a read command, memory 106 outputs the requested data on the DQs. In response to a status register read command, which initiates a status register read mode, followed by a read command, memory 106 outputs the status register values on the DQs. In one embodiment, the status register read mode is terminated automatically based on a fixed burst length. In another embodiment, the status register read mode is terminated in response to a burst stop command or a precharge command.

Host 102 includes logic, firmware, and/or software for controlling the operation of memory 106. In one embodiment, host 102 is a microprocessor or other suitable device capable of passing a clock signal, address signals, command signals, and data signals to memory 106 through memory communication path 104 for reading data from and writing data to memory 106. Host 102 passes a clock signal, address signals, command signals, and data signals to memory 106 through memory communication path 104 to read data from and write data to memory 106 and to read status register values from status register 108. The status register values read from status register 108 and the data read from memory 106 are passed to host 102 through memory communication path 104.

Memory 106 includes circuits for communicating with host 102 through memory communication path 104, for reading and writing data in memory 106, and for reading status register values from status register 108. Memory 106 includes a Random Access Memory (RAM), such as a Dynamic Random Access Memory (DRAM), Synchronous Dynamic Random Access Memory (SDRAM), Double Data Rate Synchronous Dynamic Random Access Memory (DDR-SDRAM), low power SDRAM (e.g., Mobile-RAM), or other suitable memory. Memory 106 responds to memory read requests from host 102 and passes the requested data to host 102. Memory 106 responds to write requests from host 102 and stores data in memory 106 passed from host 102. Memory 106 also responds to status register read requests from host 102 and passes the status register values from status register 108 to host 102.

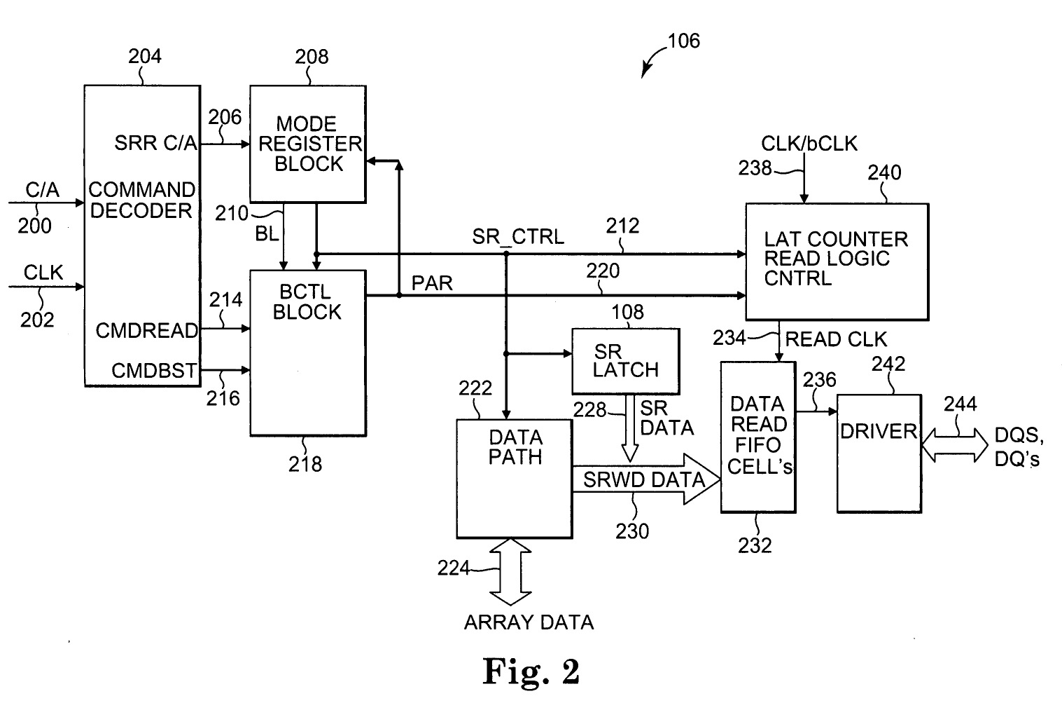

FIG. 2 is a block diagram illustrating one embodiment of memory 106. Memory 106 includes command decoder 204, mode register block 208, burst control block 218, latency counter and read logic controller 240, status register latch 108, data path 222, data read first-in first-out (FIFO) cells 232, and driver 242.

A first input of command decoder 204 receives command and address (C/A) signals on C/A signal path 200. In one embodiment, C/A signals on C/A signal path 200 are received from host 102 through memory communication path 104. A second input of command decoder 204 receives a clock (CLK) signal on CLK signal path 202. In one embodiment, command decoder 204 receives the CLK signal from host 102 through memory communication path 104. A first output of command decoder 204 is electrically coupled to a first input of mode register block 208 through status register read command and address (SRR C/A) signal path 206. A second output of command decoder 204 is electrically coupled to a first input of burst control block 218 through read command (CMDREAD) signal path 214. A third output of command decoder 204 is electrically coupled to a second input of burst control block 218 through burst stop command (CMDBST) signal path 216.

A first output of mode register block 208 is electrically coupled to a third input of burst control block 218 through burst length (BL) signal path 210. A second output of mode register block 208 is electrically coupled to a fourth input of burst control block 218, a first input of latency counter and read logic controller 240, an input of status register latch 108, and an input of data path 222 through status register control (SR_CTRL) signal path 212. The output of burst control block 218 is electrically coupled to a second input of mode register block 208 and a second input of latency counter and read logic controller 240 through pulse active read (PAR) signal path 220.

Data path 222 receives array data from an array of memory cells (not shown) through array data path 224. The output of data path 222 is electrically coupled to the data input of data read FIFO cells 232 through spine read/write data (SRWD) bus 230. The output of status register latch 108 is electrically coupled to read/write data bus 230 through status register data bus 228.

A third input of latency counter and read logic controller 240 receives the clock (CLK) signal and an inverted clock (bCLK) signal on CLK/bCLK signal path 238. In one embodiment, latency counter and read logic controller 240 receives the CLK and bCLK signals from host 102 through memory communication path 104. An output of latency counter and read logic controller 240 is electrically coupled to an input of data read FIFO cells 232 through read clock (READ CLK) signal path 234. The output of data read FIFO cells 232 is electrically coupled to an input of driver 242 through data path 236. Driver 242 provides the data strobe (DQS) signal and data (DQ) signals on DQS and DQ signal path 244. In one embodiment, driver 242 provides the DQS and DQ signals to host 102 through memory communication path 104.

Command decoder 204 receives the C/A signals on C/A signal path 200 and the CLK signal on CLK signal path 202 to provide the SRR C/A signals on SRR C/A signal path 206, the CMDREAD signal on CMDREAD signal path 214, and the CMDBST signal on CMDBST signal path 216. Command decoder 204 decodes the C/A signals to provide the SRR C/A, CMDREAD, and CMDBST signals for reading data from memory 106, writing data to memory 106, and reading status register values from status register 108. In response to receiving a status register read command, which is a mode register command with defined bank addresses, on C/A signal path 200, command decoder 204 provides a status register read command to mode register block 208 through SRR C/A signal path 206. In response to receiving a burst stop command on C/A signal path 200, command decoder 204 provides a burst stop command to burst control block 218 through CMDBST signal path 216. In response to receiving a read command on C/A signal path 200, command decoder 204 provides a read command to burst control block 218 through CMDREAD signal path 214.

Mode register block 208 includes mode registers for controlling the operation of memory 106, such as the burst length. Mode register block 208 receives the SRR C/A signals on SRR C/A signal path 206 and the PAR signal on PAR signal path 220 to provide the SR_CTRL signal on SR_CTRL signal path 212 and the BL signal on BL signal path 210. With the status register read mode set to terminate automatically, mode register block 208 changes the burst length to a fixed burst length, such as two or four, and passes the fixed burst length to burst control block 218 through BL signal path 210. In another embodiment with the status register read mode set to terminate automatically, the existing burst length is maintained and mode register block 208 passes the existing burst length to burst control block 218 through BL signal path 210. With the status register read mode set to terminate in response to a burst stop command or a precharge command, the existing burst length is maintained and mode register block 208 passes the existing burst length to burst control block 218 through BL signal path 210.

In response to the status register read command, mode register block 208 activates the SR_CTRL signal on SR_CTRL signal path 212. In response to the PAR signal on PAR signal path 220, mode register block 208 deactivates the SR_CTRL signal. In one embodiment, in response to the status register read command, mode register block 208 transitions the SR_CTRL signal from logic low to logic high. In response to the PAR signal transitioning from logic high to logic low, mode register block 208 transitions the SR_CTRL signal from logic high to logic low.

Burst control block 218 receives the CMDREAD signal on CMDREAD signal path 214, the CMDBST signal on CMDBST signal path 216, the BL signal on BL signal path 210, and the SR_CTRL signal on SR_CTRL signal path 212 to provide the PAR signal on PAR signal path 220. In response to a read command, burst control block 218 activates the PAR signal. Burst control block 218 includes a burst length counter such that the PAR signal remains active until the burst length counter counts up to the burst length provided on BL signal path 210 or until a burst stop command is received. In one embodiment, in response to a read command, burst control block 218 transitions the PAR signal from logic low to logic high. After the burst length counter counts up to the burst length or a burst stop command is received, burst control block 218 transitions the PAR signal from logic high to logic low.

Data path 222 receives the SR_CTRL signal on SR_CTRL signal path 212 and array data on array data path 224 to provide array data on read/write data bus 230. In response to an inactive SR_CTRL signal, data path 222 passes array data from array data path 224 to read/write data bus 230. In response to an active SR_CTRL signal, data path 222 blocks the array data from passing to read/write data bus 230. In one embodiment, in response to a logic low SR_CTRL signal, data path 222 passes array data to read/write data bus 230. In response to a logic high SR_CTRL signal, data path 222 blocks array data from passing to read/write data bus 230.

Status register latch 108 stores status information regarding memory 106, such as internal operating signal values, temperature, serial number, etc. In response to an active SR_CTRL signal, status register latch 108 passes the status register values to status register data bus 238, which passes the status register values to read/write data bus 230 and data read FIFO cells 232. In response to an inactive SR_CTRL signal, status register latch 108 blocks the status register values from passing to status register data bus 238. In one embodiment, in response to a logic high SR_CTRL signal, status register latch 108 passes the status register values to status register data bus 238. In response to a logic low SR_CTRL signal, status register latch 108 blocks the status register values from passing to status register data bus 238.

Data read FIFO cells 232 latch the data received from read/write data bus 230. In response to an active SR_CTRL signal, data read FIFO cells 232 latch the status register values from status register latch 108. In response to an inactive SR_CTRL signal, data read FIFO cells 232 latch the array data from data path 222. In one embodiment, in response to a logic high SR_CTRL signal, data read FIFO cells 232 latch the status register values from status register latch 108. In response to a logic low SR_CTRL signal, data read FIFO cells 232 latch the array data from data path 222. Data read FIFO cells 232 pass the latched data to data path 236 in response to the READ CLK signal.

Driver 242 passes the data received on data path 236 to the DQs through data path 244 in response to the READ CLK signal. Driver 242 passes array data to the DQs in response to a normal memory array access. Driver 242 passes the status register values in response to a status register access.

Latency counter and read logic controller 240 receives the CLK signal and the bCLK signal on CLK/bCLK signal path 238, the SR_CTRL signal on SR_CTRL signal path 212, and the PAR signal on PAR signal path 220 to provide the READ CLK signal on READ CLK signal path 234. Latency counter and read logic controller 240 delays the PAR signal based on the latency value. In response to the delayed PAR signal, latency counter and read logic controller 240 provides the READ CLK signal to clock out the data from data read FIFO cells 232 through data path 236 to driver 242. Also, in response to the delayed PAR signal, latency counter and read logic controller 240 provides a READ CLK signal to strobe the data from driver 242 passed to the DQs through data path 244.

In operation, host 102 provides a status register read command to command decoder 204 to initiate a status register read mode. The status register read command includes a mode register command (MRS) with a defined bank address. In response to the mode register command, command decoder 204 issues the SRR C/A signal to mode register block 208. In response to the SRR C/A signal, mode register block 208 activates the SR_CTRL signal. In response to the active SR_CTRL signal, data path 222 blocks the array data from passing to read/write data bus 230 and status register latch 108 passes the status register values to read/write data bus 230 through status register data bus 228. The status register values are latched in data read FIFO cells 232.

Next, host 102 provides a read command to command decoder 204. In response to the read command, command decoder 204 provides a read command to burst length control block 218. In response to the read command, burst control block 218 activates the PAR signal. Latency counter and read logic controller 240 delays the PAR signal based on the latency. In response to the delayed PAR signal, latency counter and read logic controller 240 provides the READ CLK signal to clock the status register values out of data read FIFO cells 232. Driver 242 receives the status register values and passes the status register values to the DQs with the DQS signal.

In one embodiment, the status register read mode is terminated automatically in response to a fixed burst length. In response to the burst length counter in burst control block 218 counting up to the burst length, burst control block 218 deactivates the PAR signal. In another embodiment, the status register read mode is terminated in response to a burst stop command or a precharge command. In response to a burst stop command or precharge command, burst control clock 218 deactivates the PAR signal. These options can be selected by using metal wiring options. In response to burst control block 218 deactivating the PAR signal, mode register block 208 deactivates the SR_CTRL signal.

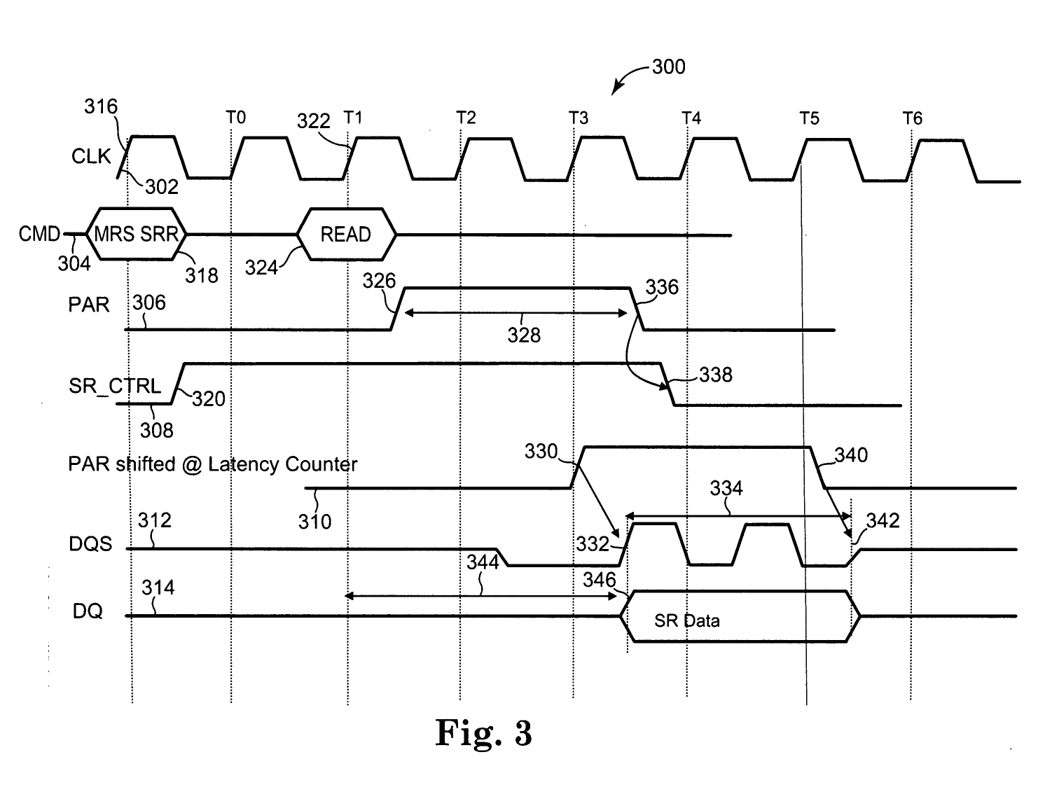

FIG. 3 is a timing diagram 300 illustrating one embodiment of the timing of signals for memory 106. Timing diagram 300 includes CLK signal 302 on CLK signal path 202 and CLK/bCLK signal path 238, command (CMD) signal 304 on C/A signal path 200, PAR signal 306 on PAR signal path 220, SR_CTRL signal 308 on SR_CTRL signal path 212, shifted PAR signal 310, DQS signal 312, and DQ signal 314.

Host 102 issues a mode register (MRS) status register read (SRR) command 318 on CMD signal 304. In response to rising edge 316 of CLK signal 302, command decoder 204 decodes mode register status register read command 318. In response to decoding mode register status register read command 318, command decoder 204 provides a status register read command to mode register block 208. In response to the status register read command, mode register block 208 provides rising edge 320 of SR_CTRL signal 308. In response to rising edge 320 of SR_CTRL signal 308, data path 222 blocks array data from passing to read/write data bus 230. Also in response to rising edge 320 of SR_CTRL signal 308, status register latch 108 passes the status register values to read/write data bus 230 through status register data bus 228. The status register values are latched by data read FIFO cells 232.

Host 102 issues a read command at 324. In response to rising edge 322 of CLK signal 302, command decoder 204 decodes read command 324. In response to read command 324, command decoder 204 provides a read command to burst control block 218. In response to the read command, burst control block 218 provides rising edge 326 of PAR signal 306. PAR signal 306 has a burst length of four as indicated at 328. Rising edge 326 of PAR signal 306 is delayed by latency counter and read logic controller 240 to provide rising edge 330 of shifted PAR signal 310.

In response to rising edge 330 of shifted PAR signal 310, latency counter and read logic controller 240 provides rising edge 332 of DQS signal 312. DQS signal 312 has a burst length of four as indicated at 334. After a latency of three from read command 324 as indicated at 344, status register data 346 of DQ signal 314 is strobed out by DQS signal 312. In response to falling edge 336 of PAR signal 306, mode register block 208 provides falling edge 328 of SR_CTRL signal 308. In response to falling edge 340 of shifted PAR signal 310, latency counter and read logic controller 240 deactivates DQS signal 312 at 342.

Embodiments of the present invention provide a memory having a status register read function. The status register read function allows access to an internal status register using a mode register command followed by a read command. The status register values are retrieved at the device operation frequency. In addition, the status register values are output on the same data paths as array data such that no additional status register interface to the memory device is used.

What is claimed is:

1. A memory comprising:
a status register; and
a read/write data bus,
wherein the status register is configured to pass status register values to the read/write data bus in response to a status register read command.

2. The memory of claim 1, further comprising:
data read first-in first-out cells for latching the status register values from the read/write data bus.

3. The memory of claim 1, further comprising:
a data path configured to pass memory array data to the read/write data bus.

4. The memory of claim 3, further comprising:
a mode register block configured to activate a first control signal in response to the status register read command,
wherein the status register is configured to pass the status register values to the read/write data bus in response to the first control signal, and
wherein the data path is configured to block memory array data from passing to the read/write data bus in response to the first control signal.

5. The memory of claim 4, further comprising:
a burst length control block configured to provide a second control signal in response to a read command,
wherein the mode register block is configured to deactivate the first control signal in response to the second control signal.

6. A memory comprising:
a mode register block configured to activate a first control signal in response to a status register read command;
a status register configured to pass status register values to a data bus in response to the first control signal; and
an array data path configured to block array data from passing to the data bus in response to the first control signal.

7. The memory of claim 6, further comprising:
a burst length control block configured to activate a second control signal in response to a read command,
wherein the mode register block is configured to deactivate the first control signal in response to the second control signal.

8. The memory of claim 7, wherein the burst length control block is configured to deactivate the second control signal based on a burst length signal.

9. The memory of claim 7, wherein the burst length control block is configured to deactivate the second control signal in response to a burst stop command.

10. The memory of claim 7, wherein the burst length control block is configured to deactivate the second control signal in response to a precharge command.

11. The memory of claim 6, wherein the memory comprises a dynamic random access memory.

12. A dynamic random access memory comprising:
means for storing status data; and
means for passing the status data to output pads of the memory in response to a status data read command followed by a read command.

13. The memory of claim 12, further comprising:
means for exiting a status data read mode in response to a burst stop command.

14. The memory of claim 12, further comprising:
means for exiting a status data read mode in response to a precharge command.

15. The memory of claim 12, further comprising:
means for exiting a status data read mode based on a fixed burst length.

16. The memory of claim 12, further comprising:
means for blocking memory array data from passing to the output pads of the memory in response to the status data read command.

17. A method for reading a status register in a memory, the method comprising:
receiving a status register read command;
passing status register values from a status register to a data bus in response to the status register read command;
receiving a read command; and
outputting the status register values on data pads of the memory in response to the read command.

18. The method of claim 17, further comprising:
blocking memory array data from passing to the data bus in response to the status register read command.

19. The method of claim 17, further comprising:
activating a status register control signal in response to the status register read command to pass the status register data from the status register to the data bus.

20. The method of claim 17, further comprising:
activating a pulse active read signal in response to the read command; and
delaying the pulse active read signal based on a latency,
wherein outputting the status register values comprises outputting the status register values in response to the delayed pulse active read signal.

21. A method for reading a status register in a memory, the method comprising:
receiving a status register read command;
activating a first signal in response to the status register read command;
blocking memory array data from passing to a data bus in response to the first signal;
passing status register values from a status register to the data bus in response to the first signal;
latching the status register values from the data bus in data read latches;
receiving a read command;
activating a second signal in response to the read command; and
outputting the status register data from the data read latches in response to the second signal.

22. The method of claim 21, further comprising:
deactivating the first signal in response to the second signal.

23. The method of claim 21, further comprising:
deactivating the second signal based on a fixed burst length.

24. The method of claim 21, further comprising:
deactivating the second signal in response to a burst stop command.

25. The method of claim 21, further comprising:
deactivating the second signal in response to a precharge command.
